(19) United States
(12) Patent Application Publication
(10) Pub. No.: US 2010/0309558 A1
(43) Pub. Date: Dec. 9, 2010

(54) DIODE LASER HAVING A BEAM-FORMING DEVICE

(76) Inventor: Bernd Ozygus, Berlin (DE)

Correspondence Address: KENYON & KENYON LLP, ONE BROADWAY, NEW YORK, NY, 10004, US

(21) Appl. No.: 12/734,059

(22) PCT Filed: Sep. 23, 2008
(86) PCT No.: PCT/EP2008/062656

§ 371 Date: Jul. 29, 2010

(30) Foreign Application Priority Data
Oct. 10, 2007 (DE) 10 2007 048 606.7

(51) Int. Cl. G02B 27/30; G02B 27/12

(52) U.S. Cl. 359/628; 359/641

(57) ABSTRACT

In a diode laser having a beam-forming device, a plurality of functions are combined in a collimating and focusing lens. In particular, the functions of an SAC lens and a focusing lens are combined in the collimating and focusing lens.

### BACKGROUND OF THE INVENTION

1. Field of the Invention

The present invention relates to a diode laser having an emitter array and a beam-forming device.

2. Description of Related Art

Laser ignition devices for internal combustion engines and gas turbines are already known. They include a pumped light source, a fiber optic device, and a laser device. Using the pumped light produced by the pumped light source and transferred by the fiber optic device, the laser device produces a laser pulse which is focused on the so-called ignition point. This ignition point is located within the combustion chamber of the internal combustion engine.

To be able to inject the laser light emitted by the pumped light source into the fiber optic device with as little loss as possible, a beam-forming device is provided between the pumped light source and the fiber optic device.

A diode laser having a device for beam forming is known from published German patent document DE 10 2004 006 932 B2. In this diode laser, the ends of the optical fibers are deformed in such a way that they are fused to the neighboring optical fibers and a rectangular cross section is obtained. The intended result is that the laser light emitted by the emitters of the diode laser will be optimally injected into the optical fibers.

Since future plans for the mass production of laser ignition devices call for the production of large numbers of units, the cost-effective manufacture of all components of the laser ignition is of great economic significance.

### BRIEF SUMMARY OF THE INVENTION

An object according to the present invention is to provide a diode laser having a beam-forming device suitable as a pumped light source, which with respect to the number of components, installation space requirements, reliability, manufacturing costs of the individual components, and also the assembly costs, has definite advantages compared to the related art.

In a diode laser having at least one emitter array and having one beam-forming device for the laser light exiting the emitter array, the beam-forming device having a fast axis collimating (FAC) lens, a slow axis collimating (SAC) lens, and a preferably aspherical focusing lens, this objective is achieved according to the present invention in that the functions of the SAC lens and the focusing lens are combined in a collimating and focusing lens. It is possible to implement one or both functions on the surface facing the emitter array or on the surface facing away from the emitter array. Alternatively, it is possible to implement one or a plurality of these functions, for example that of the FAC lens, using a gradient index lens. Information concerning these lenses may be found, for example, on the Internet at www.grintech.de, to which reference is herewith made. The essential advantages of the collimating and focusing lens according to the present invention are obvious:

First, the number of components is reduced, which has a positive impact on the manufacturing costs and the installation space requirements. Moreover, it is no longer necessary to position the SAC collimating lens and the aspherical focusing lens, which are implemented as separate lenses in the related art, precisely relative to the pumped light source. Due to the integration of both functions in one lens, only one adjustment operation is now necessary.

Finally, the small number of optical components and the elimination of the necessity to position both lenses relative to one another also significantly reduce the assembly expense while simultaneously increasing the system's reliability.

Another reduction of the system costs may be achieved in that one or both surfaces of the collimating and focusing lens divides the pumped light exiting it and focuses it on two or more focal points. This division and focusing on a plurality of focal points may, for example, have the result that the optically active surface of the collimating and focusing lens functions like a plurality of adjacently situated collimating and focusing lenses. The division of the pumped light may make it possible for it to be injected, in a targeted manner, into different fibers of a fiber optic device so that only very low losses occur when the pumped light is transferred from the diode laser into the fiber optic device.

A significant reduction of the conversion losses may be achieved if the beam-forming device includes a fast axis collimating lens, an optically effective surface of the FAC lens being situated directly upstream from the emitter array.

This makes it possible to collimate the comparatively large exit angle of the pumped light in the direction of the fast axis of approximately 30° to 60° relatively strongly, further reducing the losses in the transfer of the pumped light from the diode laser into the fiber optic device. In addition, it is also possible for the FAC lens to additionally assume a focusing function, depending on the distance to the emitter array.

The focal distances of the FAC lens are advantageously in a range between 0.6 mm and 1.2 mm.

A particular advantageous embodiment according to the present invention provides that one surface of the collimating and focusing lens facing the emitter array is designed as an FAC lens. This may save an additional optical component with the aforementioned positive effects with regard to manufacturing costs, installation space requirements, and assembly costs.

The function of the slow axis collimation of the collimating and focusing lens according to the present invention is achieved by adjacently situated cylindrical lenses, the longitudinal axes of these cylindrical lenses being parallel to the fast axis of the diode laser.

Correspondingly, the surface of the collimating and focusing lens according to the present invention embodied as an FAC lens has, for example, a prismatic, in particular cylindrical, shape. One longitudinal axis of the prismatic surface embodied as an FAC lens runs parallel to the slow axis of the diode laser.

The collimating and focusing lens according to the present invention may also be used if the diode laser has a plurality of emitter arrays stacked one on top of the other in the direction of the fast axis so that they form a microstack emitter array. It is advantageous in particular that due to the small spacing of the individual emitters of a microstack amounting to only a few micrometers, one common FAC lens is sufficient for all emitters of a microstack situated one on top of the other or of one microstack emitter array. In particular, the necessary precision of the beam forming is also achieved for the provision of pumped light for a laser ignition device.

The collimating and focusing lens according to the present invention may be manufactured by hot pressing, further reducing the manufacturing costs and guaranteeing the necessary optical quality.

### BRIEF DESCRIPTION OF THE SEVERAL VIEWS OF THE DRAWING

FIG. 1a shows a schematic representation of an internal combustion engine having a laser-based ignition device.

FIG. 1b shows a schematic representation of the ignition device of FIG. 1.

FIG. 2 shows a simplified representation of a diode laser according to the present invention.

FIGS. 3 to 5 show various views of a diode laser's beam-forming device.

FIGS. 6 to 8 show various example embodiments of beam-forming devices according to the present invention.

### DETAILED DESCRIPTION OF THE INVENTION

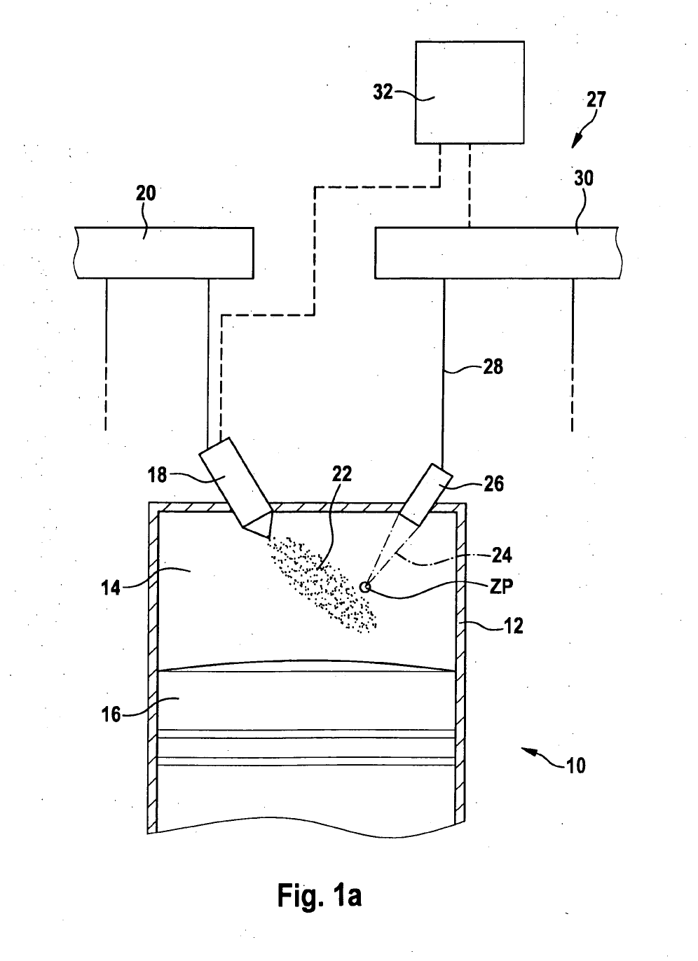

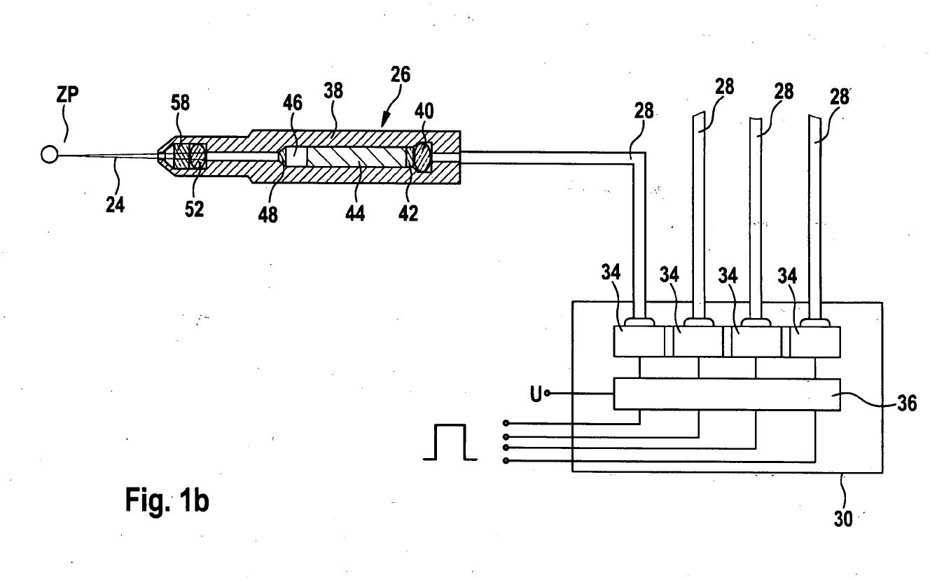

An internal combustion engine is denoted in aggregate in FIG. 1a by reference numeral 10. It may be used for driving a motor vehicle which is not shown. Internal combustion engine 10 includes a plurality of cylinders, of which only one is shown in FIG. 1 and is denoted by reference numeral 12. A combustion chamber 14 of cylinder 12 is defined by a piston 16. The fuel required for combustion is injected directly into combustion chamber 14 or into an intake manifold, which is not shown, of internal combustion engine 10 via an injector 18. The injector is in turn supplied with fuel by a fuel pressure accumulator 20 referred to as a rail.

Fuel 22 injected into combustion chamber 14 is ignited using a laser pulse 24 in an ignition point ZP. Laser pulse 24 is emitted into combustion chamber 14 by a laser device 26. For this purpose, laser device 26 is fed pumped light via a fiber optic device 28, the pumped light being provided by a pumped light source 30. Pumped light source 30 is controlled by a control unit 32 which, among other things, also activates injector 18. The components cited constitute a so-called laser ignition device 27.

As FIG. 1b shows, pumped light source 30 supplies a plurality of fiber optic devices 28 for various laser devices 26, each of which is assigned to a cylinder 12 of internal combustion engine 10. To that end, pumped light source 30 has a plurality of pumped light sources 34 which are connected to a pulse current supply 36. The presence of a plurality of individual pumped light sources 34 simultaneously implements a “quiescent” distribution of pumped light to various laser devices 26 so that no optical distributors or the like are necessary between pumped light source 30 and laser devices 26.

Laser device 26 has, for example, a laser-active solid 44 having a passive Q-switch 46, which, together with an input mirror 42 and an output mirror 48, forms an optical resonator. When pumped light generated by pumped light source 30 is applied to it, laser device 26 generates a laser pulse 24 in a manner known per se which is focused through a focusing lens 52 onto an ignition point ZP located in combustion chamber 14 (FIG. 1a). The components present in housing 38 of laser device 26 are separated from combustion chamber 14 by a combustion chamber window 58.

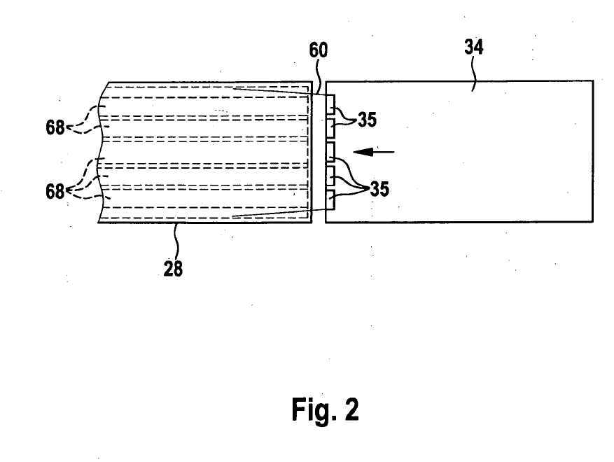

FIG. 2 shows a schematic top view of a pumped light source 34. As shown in FIG. 2, pumped light source 34 has a plurality of emitters 35. Pumped light 60 emitted by emitters 35 is used for the optical pumping of laser device 26 (FIG. 1b) and of laser-active solid 44 situated in it and is injected into fiber optic device 28.

Fiber optic device 28 includes a large number of optical fibers 68 which are also denoted below as fibers 68. To be able to inject pumped light 60 emitted by emitters 35 into fibers 68 of fiber optic device 28 with as little loss as possible, one or a plurality of beam-forming devices not shown in FIG. 2 are provided between pumped light source 34 and fiber optic device 28 and will be explained in greater detail below.

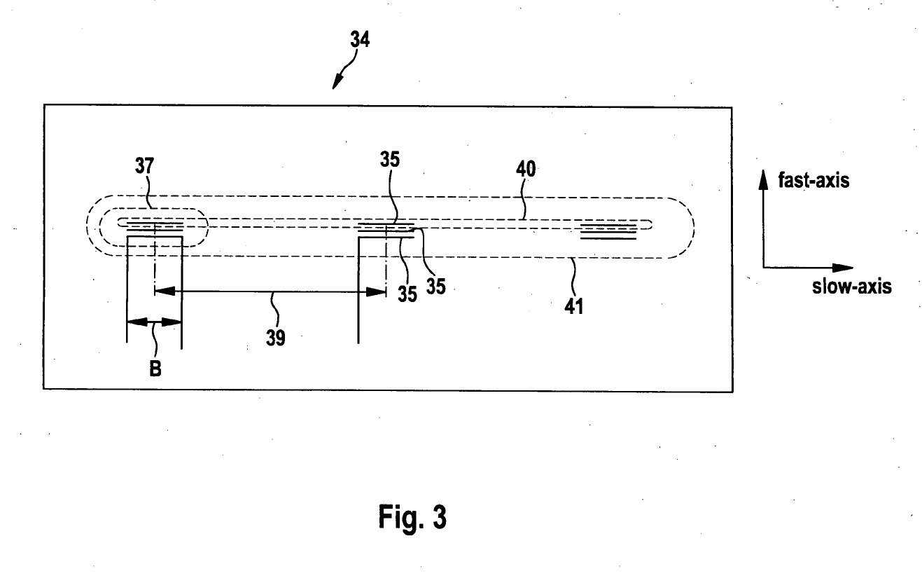

FIG. 3 shows an exemplary front view of a pumped light source 34 designed as a diode laser. In connection with the present invention, the terms pumped light source 34 and diode laser 34 are used synonymously.

FIG. 3 shows a total of nine linear emitters 35, not all of which are provided with reference numerals for the sake of clarity. These emitters 35 represent a linear light source, having a height of approximately 1 μm and a width B of approximately 60 μm to 200 μm. In the example shown, three emitters 35 are placed one on top of the other in the direction of the fast axis and form a so-called microstack 37. The spacing of emitters 35 combined in a microstack 37 amounts to only a few micrometers so that a microstack 37 may also be seen as a linear light source. In real diode lasers 34, the numbers of emitters 35 and of microstacks 37 are significantly larger. For the sake of clarity, only comparatively few emitters 35 and microstacks 37 are shown in the figures.

The spacing between two adjacent microstacks 37 in the direction of the slow axis from center to center is frequently referred to as pitch 39 and may, for example, amount to 450 μm.

A row of emitters 35 situated next to one another in the direction of the slow axis [is] denoted as emitter array 40. As the three microstacks 37 in the example shown are situated in an array in the direction of the slow axis, they are referred to in connection with the present invention as a microstack array 41. Due to the small dimension of microstack 37 in the direction of the fast axis, the optical properties of an emitter array 40 and of a microstack array 41 are essentially identical. This offers substantial advantages with respect to the design of the beam-forming device.

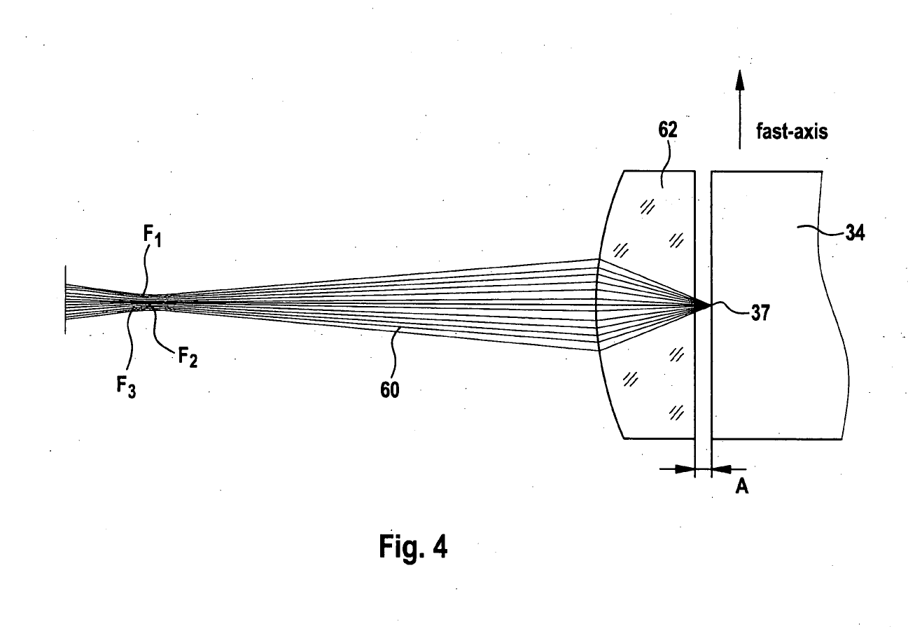

FIG. 4 shows a side view of a diode laser 34 and one exemplary embodiment of a so-called fast axis collimating lens 62 according to the present invention. The fast axis collimating lens will also be denoted below as FAC lens 62. As pumped light 60 emitted by microstacks 37 in the direction of the fast axis has a very large emission angle of approximately 30° to 60°, pumped light 60 must be collimated by an FAC lens 62. This FAC lens is normally a short-focal-length cylindrical lens situated in the immediate vicinity of microstacks 37, and is parallel to the slow axis.

Spacing A between diode laser 34 and FAC lens 62 amounts to, for example but not compulsorily, 90 μm. The focal distances of FAC lens 62 are typically in a range between 0.6 mm and 1.2 mm. In the present case, the FAC lens is not used for collimating pumped light 60 exiting microstack emitters 37 but instead also simultaneously focuses pumped light 60.

Because, as is seen in FIG. 3, microstack emitter 37 in the described exemplary embodiment has three emitters 35 situated on top of one another, focal points F₁, F₂, and F₃ of microstack emitter 37 are interspaced in the direction of the fast axis. This spacing between the three focal points F₁, F₂, and F₃ presents no problems for use in a laser ignition device.

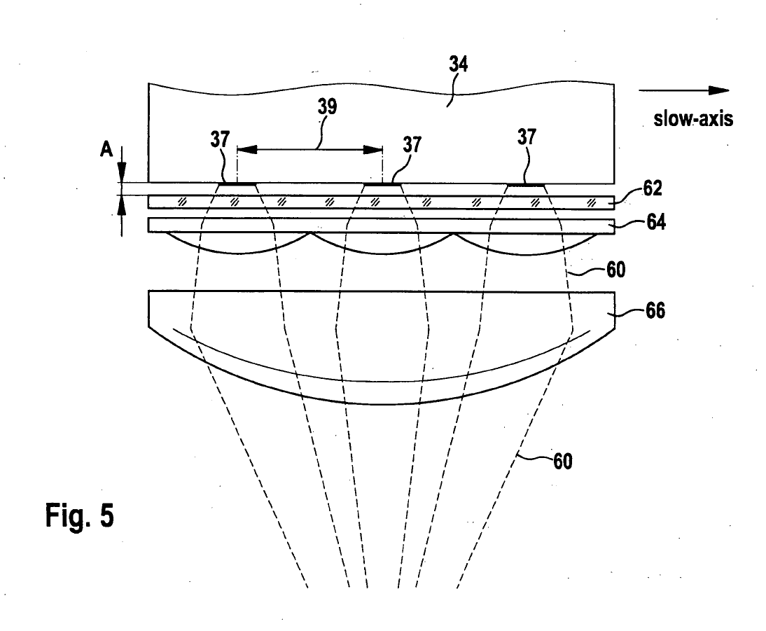

FIG. 5 shows a top view of a pumped light source 34 and the upstream beam-forming device according to the related art. As has already been explained with reference to FIG. 4, an FAC lens 62 is situated immediately upstream from pumped light source 34. Furthermore, an SAC array 64, which is made up of a plurality of adjacently situated cylindrical lenses, is present for achieving a slow axis collimation. The number of microstacks 37 corresponds to the number of cylindrical lenses of SAC array 64.

SAC array 64 improves the beam quality and in particular the focusability of pumped light 60 emitted by microstacks 37 in the direction of the slow axis. The possibility for reducing the slow axis divergence of pumped light source 34 is determined by the width of emitter 35 or microstacks 37 and pitch 39 between microstacks 37. Since pitch 39 may not fall below a minimum amount for reasons of improved heat dissipation, the beam quality of pumped light 60 emitted by pumped light source 34 is predetermined and must be collimated. In usual structures having an emitter width of 150 μm and a pitch 39 of 500 μm, the divergence of the pumped light in the slow axis direction is reduced maximally by a factor of 2.3.

To be able to inject pumped light 60 into a fiber 68 of a fiber optic device (see FIG. 2), the pumped light must still be focused after exiting the SAC array. Due to the large angle (high numerical aperture) necessary, for example, aspherical lenses 66 are used for this purpose.

As can be readily seen from the top view according to FIG. 5 which schematically depicts the beam-forming device known from the related art, the expense for such a beam-forming device is substantial. First, three lenses, namely FAC lens 62, SAC array 64, and aspherical focusing lens 66 are necessary. This of course entails a very high manufacturing expense. In addition, all lenses 62, 64, and 66 must be exactly positioned relative to pumped light source 34. This results in considerable assembly and adjustment expense.

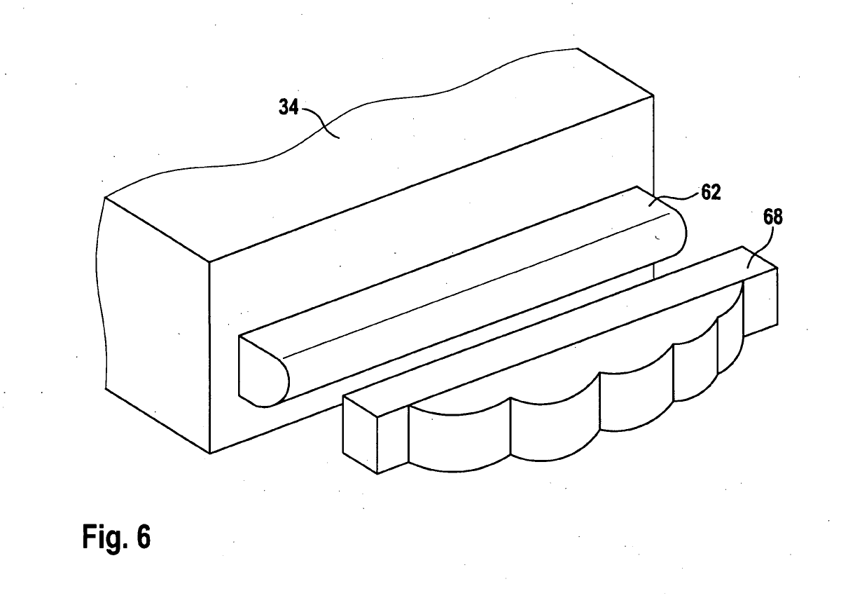

An exemplary embodiment of a beam-forming device is shown isometrically in FIG. 6. The functions of the SAC array and the focusing lens are combined in a collimating and focusing lens 68 according to the present invention. In the exemplary embodiment shown in FIG. 6, the surface of collimating and focusing lens 68 facing away from pumped light source 34 is therefore made up of a superposition of an aspherical focusing lens and a plurality of cylindrical lenses parallel to one another which have the function of an SAC array. Due to the aspheric curvature of collimating and focusing lens 68, the distances of the cylindrical lenses to pumped light source 34 are different. Since the focal point of the cylindrical lenses (without reference numerals in FIG. 6) must be located roughly at the light exit of microstacks 37, the focal distances of the individual cylindrical lenses are location-dependent and different from one another.

As already demonstrated by the comparison of FIGS. 5 and 6, combining SAC array 64 and focusing lens 66 in a common collimating and focusing lens 68 not only reduces the number of components but also saves considerable installation space.

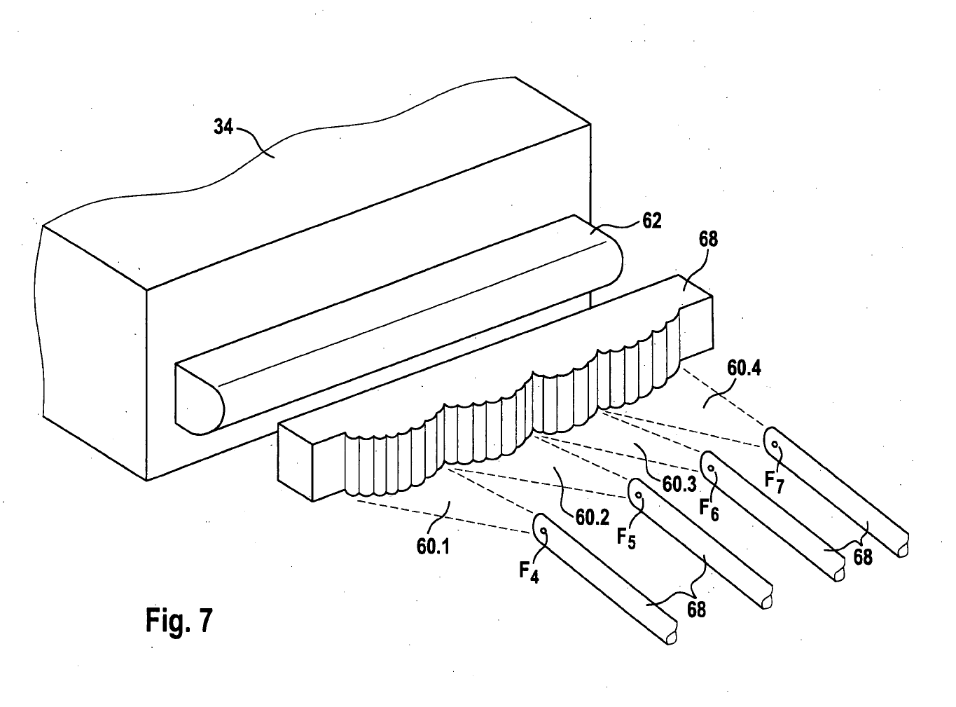

Now if, as indicated in the second exemplary embodiment according to FIG. 7, the pumped light emitted by pumped light source 34 is to be injected onto a total of four foci in for example four fibers 68 of an optical fiber, it is then possible and advantageous to integrate this division of the pumped light and its focusing onto four spaced apart focal points for example also into the surface of collimating and focusing lens 68 facing away from pumped light source 34. In this exemplary embodiment, collimating and focusing lens 68 focuses not only on one focal point, but instead focuses the light emitted by pumped light source 34 on four foci denoted as F₄ to F₇ in FIG. 7. This makes it possible to divide the pumped light emitted by pumped light source 34 into a plurality of sub-beams 60.1 to 60.4 and assign it to individual fibers 68 of a fiber optic device 28. In addition, it is necessary to situate the ends of fibers 68 at focal points F₁ to F₇.

The pumped light divided into four sub-beams is denoted by reference numerals 60.1, 60.2, 60.3 and 60.4 in FIG. 7. In this exemplary embodiment not only three microstacks 37 are present in pumped light source 34, as indicated in the simplified representations of FIGS. 3 to 5, but significantly more. Thus, for example, nineteen microstacks 37 (not shown in FIGS. 6 and 7) may be present. The division of the spherical lens into four discrete aspherical lenses in the exemplary embodiment according to FIG. 7 makes it possible to integrate another function, namely the division of the pumped light and focusing of pumped light 60 onto four different focal points F₄ to F₇, into collimating and focusing lens 68 according to the present invention without additional manufacturing costs and without additional installation space requirements. This of course also results in a reduction of the assembly expense.

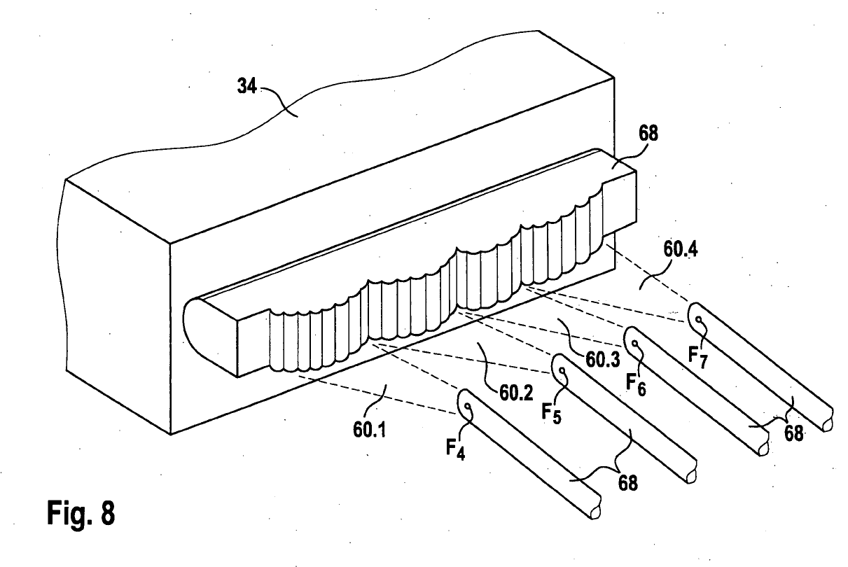

A further reduction of the number of components and assembly expense, as well as the installation space requirements, is achieved by, as indicated in FIG. 8, also integrating the function of FAC lens 62 into collimating and focusing lens 68. In this in particular space-saving and nonetheless cost-effective version, only collimating and focusing lens 68 must be positioned relative to the diode laser to ensure that both the FAC collimation and the SAC collimation and the subsequent focusing and division of the pumped light take place with the necessary precision and accuracy. This results in additional advantages with respect to installation space requirements and manufacturing costs. Since collimating and focusing lens 68 according to the present invention has dimensions of approximately 1 mm×3 mm×10 mm, it may also be manufactured by hot pressing in an appropriate molding tool having sufficient precision at acceptable costs.

In principle, it is possible to implement all functions on the surface of collimating and focusing lens 68 facing or facing away from diode laser 34.

1-13. (canceled)

14. A diode laser, comprising:
at least one array of pumped-light emitters; and
a beam-forming device for laser light emitted by the array of pumped-light emitters, wherein the beam-forming device includes a single combined collimating and focusing lens configured to perform the functions of an SAC lens and an aspherical focusing lens.

15. The diode laser as recited in claim 14, wherein at least one of the functions of the SAC lens and the aspherical focusing lens is implemented on a surface of the combined collimating and focusing lens facing away from the array of pumped-light emitters.

16. The diode laser as recited in claim 14, wherein at least one of the functions of the SAC lens and the aspherical focusing lens is implemented on a surface of the combined collimating and focusing lens facing the array of pumped-light emitters.

17. The diode laser as recited in claim 14, wherein the combined collimating and focusing lens is configured to divide a pumped light so that multiple beams exit the combined collimating and focusing lens.

18. The diode laser as recited in claim 17, wherein the combined collimating and focusing lens is configured to simultaneously focus on a plurality of foci.

19. The diode laser as recited in claim 14, wherein the beam-forming device includes a fast-axis collimating lens situated directly upstream from the array of pumped-light emitters.

20. The diode laser as recited in claim 19, wherein a surface of the combined collimating and focusing lens facing the array of pumped-light emitters is configured as the fast-axis collimating lens.

21. The diode laser as recited in claim 20, wherein at least one of the function of the fast-axis collimating lens and the function of the collimating and focusing lens is implemented as a gradient index lens.

22. The diode laser as recited in claim 20, wherein a plurality of adjacently situated cylindrical lenses oriented parallel to the fast-axis direction of the diode laser is formed on the surface of the collimating and focusing lens facing away from the emitter array.

23. The diode laser as recited in claim 22, wherein a focal distance of the cylindrical lenses is a function of the distance between the collimating and focusing lens and the emitter array.

24. The diode laser as recited in claim 21, wherein the surface of the collimating and focusing lens configured as the fast-axis collimating lens is cylindrical.

25. The diode laser as recited in claim 21, wherein multiple emitter arrays are stacked one on top of the other in the direction of the fast axis and form at least one microstack emitter array.

26. The diode laser as recited in claim 21, wherein the collimating and focusing lens is manufactured by hot pressing.
